(19) United States
(12) Patent Application Publication
(10) Pub. No.: US 2012/0059634 A1
(43) Pub. Date: Mar. 8, 2012

(54) METHOD FOR OPTIMIZING THE POSITIONING OF WELLS IN AN OIL RESERVOIR

(76) Inventors: Zyed BOUZARKOUNA, Paris (FR); Didier Yu Ding, Le Pecq (FR); Anne Auger, Orsay Cedex (FR); Marc Schoenauer, Villejuif (FR)

(21) Appl. No.: 13/215,303

(22) Filed: Aug. 23, 2011

(30) Foreign Application Priority Data
Sep. 3, 2010 (FR) 10/03.522

(51) Int. Cl. G06F 17/10; G06F 7/60; G06G 7/57

(52) U.S. Cl. 703/2; 703/10

(57) ABSTRACT

A method is disclosed for determining well placements, or drainage areas, in a hydrocarbon reservoir to facilitate operation of the reservoir. Drainage area configurations are generated randomly, by generating, for each configuration, placements for each drainage area. The placements of each drainage area are determined to optimize a quality criterion, by an iterative optimization algorithm during which for first iterations, the quality criterion is evaluated by a flow simulator, and for subsequent iterations, an approximate evaluation model of the quality criterion is constructed. The quality of the approximate model is evaluated and the quality criterion is determined by the approximate model or by the flow simulator according to the quality of this approximate model.

### BACKGROUND OF THE INVENTION

1. Field of the Invention

The present invention relates to the technical field of the oil industry. In particular, the invention makes it possible to optimize the operation of an oil deposit by optimizing placement of drainage areas drilled to produce hydrocarbons.

2. Description of the Prior Art

The extraction of hydrocarbons contained in an oil deposit is done by means of wells drilled through the geological formations. This extraction entails the drilling of producing wells through which the hydrocarbons are raised to the surface, and sometimes the drilling of injection wells through which a product (water, gas, additives, etc.) is injected to improve the recovery of the hydrocarbons. Within the oil deposit, these wells define drainage areas. A drainage area may also depend on the flow rate of the well, on the weather, etc.

The drilling and the equipping of such drainage areas (tubing, cement, etc.) are very costly operations. Furthermore, a drainage area that is badly positioned within the reservoir may produce only a small quantity of hydrocarbons or even produce only water. Placement of a well, and more specifically placement of the associated drainage area, is a highly influential factor on the quantity of hydrocarbons recovered from the concerned field. The placement of the drainage areas therefore conditions the quality of the recovery, in terms of volume recovered and of production cost. This quality is conventionally evaluated by means of a parameter called NPV (net present value), corresponding to the difference in the cash flows generated by the investment corresponding to the placement of the wells.

The oil industry is therefore confronted with a problem of optimization of the operation of the deposits, which is reflected in a problem of optimization of the placement of the drainage areas of the production and injection wells. Defining the placement of a drainage area involves defining its position (set of coordinates x, y and z) in the reservoir.

To define the optimum placements for the drainage areas which are the placements that will make maximizing the volume of hydrocarbons recovered while minimizing the production costs, the experts use a first tool called a “reservoir model”. A reservoir model is a representation of the subsoil and of the deposit. It is a model which discretizes the natural environment. A reservoir model thus comprises two types of objects: a mesh (or grid), and one or more maps. Each map corresponds to the distribution of a petrophysical property. Thus, each mesh has at least one petrophysical property value associated with it. A reservoir model reports on the structure, the petrophysical properties, the properties of the fluids in place within the deposit, thus describing both the structure and the behavior of the deposit concerned. This representation is constructed by means of measurements (core samples, logs, seismic surveys, etc.) made by geologists, geophysicians and petrophysicians, and a computer. The computer is used in particular to represent this object on a screen, thus facilitating its use.

The experts use a second tool called a “flow simulator”. A flow simulator is software that makes it possible to model the flows within an oil deposit represented by means of a reservoir model. The flow simulator therefore uses the reservoir model model to produce these modelings. This software makes it possible, for example, to evaluate the production of a deposit according to the decided well placements.

Methods are known that use a reservoir model and a flow simulator to optimize the placement of the wells within a deposit in order to optimize the hydrocarbon deposit production.

These methods iteratively modify, using a stochastic or deterministic optimization algorithm, several parameters defining the positions and the trajectories of the wells in the reservoir, so as to maximize a quality criterion, such as the NPV or the production of hydrocarbons. This quality criterion is quantified by an objective function.

There is known, for example, the use of genetic algorithms, simple or combined with other techniques such as kriging and neural networks. This technique is described in the following documents:
Guyaguler, B. & Horne, R. (2000). Optimization of Well Placement. Journal of Energy Resources Technology, 122, 64-70.
Guyaguler, B., Horne, R., Rogers, L. & Rosenzweig, J. (2000). Optimization of Well Placement in a Gulf of Mexico Waterflooding Project. In SPE Annual Technical Conference and Exhibition.
Yeten, B., Durlofsky, L. & Aziz, K. (2003). Optimization of Nonconventional Well Type, Location and Trajectory. SPE Journal, 8, 200-210.
Emerick, A., Silva, E., Messer, B., Almeida, L., Szwarcman, D., Pacheoco, M. & Vellasco, M. (2009). Well Placement Optimization Using a Genetic Algorithm with Nonlinear Constraints. In SPE Reservoir Simulation Symposium.

Other techniques have been described by using gradient methods in the following documents:
Handels, M., Zandvliet, M., Brouwer, D. & Jansen, J. (2007). AdjointbasedWell-Placement Optimization Under Production Constraints. In SPE Reservoir Simulation Symposium.
Sarma, P. & Chen, W. (2008). Efficient Well Placement Optimization with Graident-Based Algorithms and Adjoint Models. In SPE Intelligent Energy Conference and Exhibition.

The techniques in the following documents can also be cited:
Beckner, B. & Song, X. (1995). Field Development Planning Using Simulated Annealing Optimal Economic Well Scheduling and Placement. In SPE Annual Technical Conference and Exhibition.
Ding, D. (2008) Optimization of Well Placement Using Evolutionary Algorithms. In SPE europec/EAGE Annual Conference and Exhibition.

However, the deterministic approaches do not generally succeed in resolving this problem, because the objective function linked to the placement of the wells within the reservoir (drainage area) is an objective function which is difficult to resolve (a non-smooth, non-convex function with a number of local minima, etc.). With regard to the stochastic approaches, they represent a lengthy process requiring a very high number of flow simulations. These techniques are therefore very costly in terms of CPU time. The industrial application, by a reservoir engineer, of such techhiques is therefore difficult in practice.

It is therefore important to reduce the number of simulations needed to produce an optimization of placement of the drainage areas that meets the requirements of the engineers operating the oil reservoirs.

### SUMMARY OF THE INVENTION

Thus, the invention relates to a method for determining placements for drainage areas within a hydrocarbon reservoir that allows for an optimal operation of this reservoir, by limiting the number of flow simulations. To achieve this, the method is based on the definition of an approximate model to evaluate the quality of the operation, and on an evaluation of the quality of this approximate model.

Based on a flow simulator and a reservoir model, the method according to the invention comprises the following steps: defining a number of drainage areas to be drilled within the reservoir; choosing at least one quality criterion for the operation; and the following steps are carried out:
i. generating drainage area configurations randomly, by generating, for each configuration, placements for each drainage area;
ii. determining the placements for each drainage area that make it possible to optimize the quality criterion, by modifying the configurations by an iterative optimization algorithm during which: for first iterations, the quality criterion is evaluated by the flow simulator and of the reservoir model; and

for subsequent iterations,
an approximate evaluation model of the quality criterion is constructed, on the basis of a data structure containing a set of configurations associated with a criterion value obtained by the flow simulator;
evaluating a quality of said approximate model by an approximate ranking procedure;
determining the quality criterion by the approximate model or by the flow simulator according to the quality of the approximate model.

According to the invention, it is possible to define the approximate model by defining a distance between two configurations, by selecting k configurations of the data structure for which the distance relative to the configuration for which the criterion is evaluated is the lowest, and by defining a quadratic model of the k configurations.

According to the invention, the quality of the approximate model can be evaluated by carrying out the following steps:
a. computing the quality criterion for each configuration by the approximate model, and a first ranking of the configurations is carried out according to the value of the criterion for each configuration;
b. n configurations associated with the highest criteria are selected, and the quality criterion is computed for these n configurations by the flow simulator and of the reservoir model with each configuration and each criterion being added to the data structure;
c. the quality criterion is computed again for each configuration by the approximate model constructed on the completed data structure, and a second ranking of the configurations is carried out according to the value of the criterion for each configuration; and
d. the quality of the approximate model is evaluated by comparing the first ranking and the second ranking.

According to one embodiment, the steps i to iii are reiterated by varying the number of drainage areas.

The iterative optimization algorithm is preferentially a stochastic algorithm of CMA-ES type.

According to the invention, the drainage areas to be drilled can include multiple-branched drains.

Finally, according to the invention, the quality criterion is computed for each configuration by means of several approximate models corresponding to one or more drainage areas.

Other features and advantages of the method according to the invention will become apparent from reading the following description of nonlimiting exemplary embodiments, by referring to the figures of drawings described hereinbelow.

### BRIEF DESCRIPTION OF THE FIGURES

FIG. 1 shows the mesh of the reservoir used. It comprises a perspective view of the reservoir (a) and a plan view (b), and shows the vertical elevation of the reservoir (gray scale).

FIG. 2 shows a plan view of the mesh of the reservoir, and presents, in dark gray, preferential drilling regions Z1 and Z2.

FIG. 3 shows the trend of the best NPV value found by using the method according to the invention and compares it with the one found by using a conventional approach.

FIG. 4 shows a plan view of the mesh of the reservoir with the placements of the PROD and INJ drainage areas.

### DETAILED DESCRIPTION OF THE INVENTION

The method according to the invention comprises the following main steps:
1. a reservoir model is constructed and a flow simulator is chosen;
2. a number of drainage areas to be drilled within the hydrocarbon reservoir are defined;
3. an operation quality criterion for this reservoir is chosen;
4. drainage area configurations are generated randomly;
5. the placements of each drainage area that make it possible to optimize the quality criterion are determined by means of an iterative optimization algorithm.

### 1. Construction of a Reservoir Model and Choice of a Flow Simulator:

The first step is to construct the reservoir model which corresponds to a grid defined by the properties of the reservoir such as the porosity and permeability. This model is constructed on the basis of measurements collected from the reservoir. The construction of a reservoir model is well known.

A flow simulator is also chosen. The PumaFlow™ software (IFP Energies nouvelles, France) can be used, or a simplified simulator of the streamlines type for example, which is less costly in terms of CPU time.

2. Definition of the Number of Drainage Areas to be Drilled within the Reservoir

The expression “drainage area” is used to mean an area of the reservoir passed through by a well. In this step, the number of wells to be drilled through the reservoir is defined, defining drainage areas. These wells may be injection and/or production wells.

### 3. Choice of a Reservoir Operation Quality Criterion

The quality of the operation of the reservoir is conventionally evaluated by a parameter called NPV (net present value), corresponding to the difference in the cash flows generated by the investment corresponding to the placement of the wells.

The production of the wells can also be used.

### 4. Random Generation of Drainage Area Configurations

A drainage area configuration corresponds to the placement, within the reservoir, of all the wells to be drilled in the reservoir (placement of all the drainage areas).

A parameter λ, called population size, is defined, characterizing the number of drainage area configurations used in each generation. The initial population (first generation) is generated randomly.

The drainage area configuration is represented by the location of each drainage area within the reservoir. It may be coordinates of the points defining the ends, within the reservoir, of the wells and of its lateral drains. The scale of the problem is thus equal to the number of variables used to represent the configuration of the drainage areas.

### 5. Determination of the Placements of Each Drainage Area Making it Possible to Optimize the Quality Criterion by Means an Iterative Optimization Algorithm

After having randomly generated drainage area configurations, the placements of each drainage area which make it possible to optimize the quality criterion are determined, by modifying these configurations.

According to the invention, these configurations are modified by an iterative optimization algorithm during which:
i. for the first iterations, the quality criterion is evaluated by the flow simulator and the reservoir model; and
ii. for subsequent iterations,
   an approximate model is constructed to evaluate the quality criterion, based on a data structure containing a set of configurations associated with a criterion value obtained by the flow simulator;
   the quality of the approximate model is evaluated by an approximate ranking procedure; and
   the quality criterion is determined by the approximate model or by the flow simulator according to the quality of the approximate model.

According to one embodiment, the optimization process is performed by using a stochastic optimization algorithm of CMA-ES type. The CMA-ES algorithm is an optimization algorithm based on population evolving on each iteration (called generation). A population is defined as a set of drainage area configurations which are solutions, called individuals, of the problem. The CMA-ES algorithm therefore modifies, iteratively, the parameters of these configurations so as to maximize the objective function concerned until a fixed stop criterion is reached. This stop criterion may relate, in practice, to a maximum number of reservoir simulations or to a maximum number of iterations to be performed.

A new population is generated with a normal law defined by a mean m, a lag σ and a covariance matrix C. These parameters are updated on each iteration on the basis of the objective function values obtained, and more specifically on the basis of the ranking of the individuals according to their respective objective function values. The equations used to update the various CMA-ES parameters in this step are described in:
Hansen N. and Ostermeier A (2001). Completely Derandomized Self-Adaptation in Evolution Strategies. Evolutionary Computation, 9(2): 159-195.

A choice can be made, for example, to determine the placement of two drainage areas corresponding to an injection well and a production well, a population size equal to 40 and a stop criterion corresponding to the maximum number of generations equal to 60 iterations.

### Construction of the Approximate Model and Evaluation of its Quality

According to the invention, the optimization procedure, which requires, on each generation and for each individual, an evaluation of the objective function, based on the results obtained by the flow simulator, uses an approximate model to replace these evaluations.

According to one embodiment, it is possible to use a local regression to construct this approximate model. The quality of this approximate model is evaluated with an approximate ranking procedure.

The configurations of the drainage areas evaluated and the corresponding objective function (quality criterion) values are stored after each evaluation. All of these evaluations are stored in a data structure, and are used to compute the value of the approximate model at a given point (or individual).

To compute the value of the approximate model at a point q=(q₁, . . . , qₙ)ε [symbol] ⁿ—a point defining a drainage area configuration—denoted \hat{f}(q), the k points closest to q in the direction of distance d are selected from the data structure with the distance d being defined as follows for two points p₁ and p₂:

d(p₁,p₂)=\sqrt{(p₁−p₂)^{T}C⁻¹(p₁−p₂)}∀p₁,p₂ε [symbol] ⁿ

with:
n: the dimension of the problem which is equal to the number of variables used to identify the number of drainage areas to be drilled;
k=n(n+3)+2
C: the covariance matrix defined by CMA-ES.
\hat{f} is defined by a complete quadratic model by using

$$β ∈ {\frac{n ( n + 3 )}{2} + 1}^{} \text{:}$$

\hat{f}(q,β)=β^{T}(q₁², . . . , qₙ², q₁q₂, . . . , qₙ₋₁qₙ, q₁, . . . , qₙ,1)

To determine β, the following criterion is minimized relative to β:

$$A ( q ) = {\sum }_{j = 1}^{k} [ {( \hat{f} ( {x}_{j} , β ) - {y}_{j} )}^{2} K ( \frac{d ( {x}_{j} , q )}{h} ) ]$$

with:
xᵢ, yⱼ: respectively the j^{th} point closest to q and its objective function value;
h: the distance between q and the k^{th} point closest to q;
K: a function defined between 0 and 1 and strictly decreasing with K(0)=1 and K(1)=0. An example of K may be K(ζ)=(1−ζ²)²∀ζε[0.1].

Having determined β, the value of the approximate model at the point q concerned is computed by evaluating the complete quadratic model defined by β at this point.

An approximate ranking strategy is used to decide, on each iteration of CMA-ES, the points which must be simulated with the flow simulator and those which must be approximated by the approximate model. As soon as the data structure contains a minimum number of simulated points, on each generation, the following steps are carried out:
a the approximate model (denoted \hat{f}) is computed for each point of the generation;
b the set of the μ points with the highest approximate objective function values is identified;
c a flow simulation is carried out for each of the best nᵢₙᵢₜ drainage area configurations. The results obtained (the points and the corresponding objective function values) are added to the data structure;
d the approximate model is recomputed for each point of the generation;
e the new set of the μ points with the highest approximate objective function values is identified;
f three possible cases are considered:
   If the set of the μ points with the highest approximate objective function values remains the same, and if the point with the best approximate objective function value remains unchanged, the procedure moves on to the next step.
   If flow simulations have been carried out for a number greater than a quarter of the size of the population for a generation and if the point with the best approximate objective function value remains unchanged, the procedure moves on to the next step.
   Otherwise, the flow simulation is carried out for each of the best n_{b} well configurations. The results obtained (the points and the corresponding objective function values) are added to the data structure. The approximate model is computed for each point of the generation. The new set of the μ points with the highest approximate objective function values is identified. The step f is repeated. The procedure returns to the step for generation of a new population.
e The approximate model is accepted: the value of the approximate model is considered to replace the objective function value for the points which are not simulated with the flow simulator.

Parameters must be defined to use this methodology. It is possible, for example, to choose:
a minimum size of the data structure equal to n×(n+3)+2;
nᵢₙᵢₜ: the number of points to be initially simulated equal to 1;
n_{b}: the number of points to be simulated if the acceptance criterion for the approximate model is not satisfied equal to 1;
μ: the number of points used to define the acceptance criterion of the approximate model equal, by default, to half the population size λ. This value also corresponds to the value used to define the number of the points used for the updates to the CMA-ES parameters.

### Variant 1

According to one embodiment, the method is carried out several times with a different number of drainage areas, in order to choose the best configuration, that is to say, the one which offers the best quality criterion (highest NPV or highest well production).

According to another embodiment, it is possible to define preferential regions to contain the drainage areas. These regions may be proposed directly by the reservoir engineers. The best configuration of the drainage areas to be placed in the regions already identified is then determined. The initial population (first generation) is generated randomly in these identified regions.

### Variant 2

According to another embodiment, the overall quality criterion is divided into several quality criteria for each drainage area or set of drainage areas.

N_{cq}, the number of the quality criteria to be approximated, is defined. The overall quality criterion is therefore

$$f = {\sum }_{i = 1}^{{n}_{cq}} {f}_{i} ,$$

with fₜ the quality criterion of a drainage area or of a set of drainage areas, hereinafter called i^{th} component of the quality criterion.

According to this embodiment, an approximate model is constructed for each component of the quality criterion.

The configurations of the drainage areas evaluated and the values of the corresponding different components of the objective function (quality criterion) are stored after each evaluation. All of these evaluations are stored in a data structure, and are used to compute each of the values of the components of the approximate model at a given point (or individual).

To compute the value of the approximate model at a point q=(q₁, . . . , qₙ)ε [symbol] ⁿ—a point defining a drainage area configuration—denoted \hat{f}(q), the following is computed:

$$\hat{f} ( q ) = {\sum }_{i = 1}^{{n}_{cq}} \hat{{f}_{i}} ( q )$$

with \hat{f}ᵢ being the i^{th} component of the approximate model (that is the approximate model of the i^{th} component of the quality criterion).

For each approximate model, the different parameters on which it depends are defined. For example, it can be assumed that the approximate model of a component of the quality criterion depends only on the location of a few drainage areas.

The different components of the approximate model are thus constructed in a manner similar to that defined in the step 5.

### Exemplary Application

The method according to the invention can be used to place, within the reservoir, new wells or add new lateral drains to wells that already exist.

It can be applied to new fields or mature fields (containing wells already drilled).

In particular, an exemplary application is presented for determining the placement of two drainage areas corresponding both to a production well and an injection well in a new field, with regions identified by the reservoir engineer.

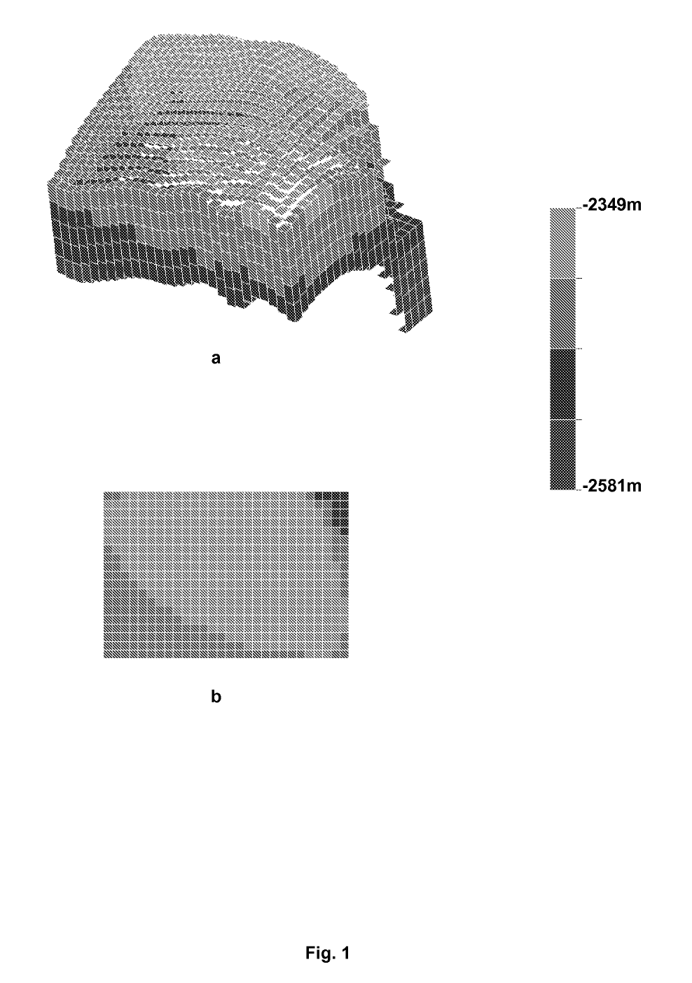

This method is applied to a synthetic reservoir. This reservoir has a size of 3420 m×5040 m×90 m. The mesh is Cartesian with 19 meshes in the direction x, 28 meshes in the direction y and 5 meshes in the direction z. The mesh size is 180 m×180 m×18 m. The vertical elevation of the reservoir is presented in FIG. 1. FIG. 1 shows the mesh of the reservoir used, and comprises a perspective view of the reservoir (a) and a plan view (b). The field concerned does not contain any well that is already drilled. It is proposed to find the best placement for each of the two drainage areas with only a main trunk (without lateral drains). The quality criterion chosen is the NPV defined as follows:

$$f = {\sum }_{n = 0}^{Y} ( \frac{1}{{( 1 + APR )}^{n}} [ {Q}_{n , o} \times {C}_{n , o} + {Q}_{n , g} \times {C}_{n , g} + {Q}_{n , w} \times {C}_{n , w} ] ) - {C}_{d}$$

in which Q_{n,p} is the production of the field concerned in the phase p in the period n, C_{n,p} is the gain or the loss associated with the production of the phase p during the period n, the phase p may represent oil, gas or water which are respectively denoted by o, g, w, APR is the annual percentage interest rate. Y is the number of periods concerned, C_{d} is the cost involved in the drilling and completion for the wells concerned, C_{d} is approximated as follows:

$${C}_{d} = {\sum }_{k = 0}^{N} {[ A \cdot {d}_{w} \cdot ln ( {l}_{w} ) \cdot {l}_{w} ]}_{k} + {\sum }_{m = 1}^{\overline{N}} {[ {C}_{jun} ]}_{m}$$

with l_{w} being the length of the drainage area (length of the well in the reservoir), d_{w} the diameter of the drainage area (diameter of the well in the reservoir), A is a constant, Cⱼᵤₙ the cost of a junction, N the total number of trunks and laterals, and N̅ the number of junctions.

The productions Q_{n,p} of the phase p for the period n are obtained by the flow simulator. In this example, the PumaFlow™ (IFP Energies nouvelles, France) flow simulator is used.

In this example, N=2 and N̅ is 0. The constants used to define the objective function are represented in the following table:

| Constants | Values |
|---|---|
| C_{n,o} | 60 $/barrel |
| C_{n,g} | −4 $/barrel |
| C_{n,w} | 0 |
| APR | 0.2 |
| A | 1000 |
| d_{w} | 0.1 m |
| Cⱼᵤₙ | 10⁵ $ |

A constraint is added to the problem which relates to the length of the drainage areas which must not exceed 1000 m.

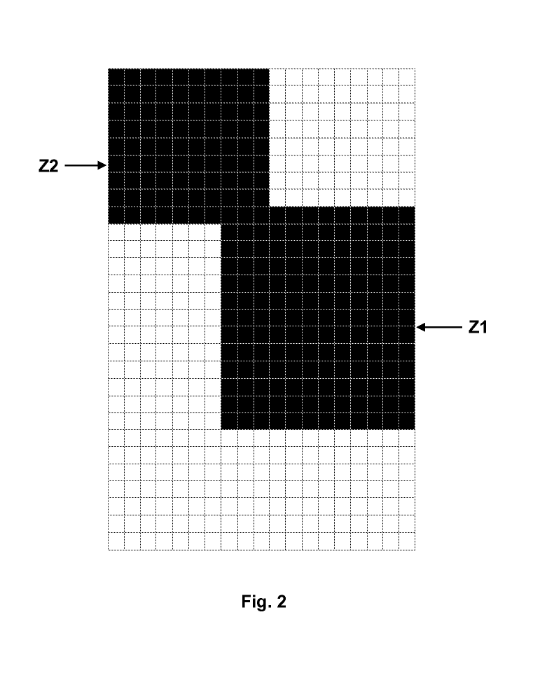

Two regions are defined for placing the drainage areas (FIG. 2). One region, denoted Z1, must contain the drainage area corresponding to the production well, and one region Z2 must contain the drainage area corresponding to the injection well. Z1 and Z2 are defined as follows:

Z1=the meshes: 8-19 according to x, 8-20 according to y and 1-5 according to z.

Z2=the meshes: 1-10 according to x, 20-28 according to y and 1-5 according to z.

FIG. 2 shows a plan view of the mesh of the reservoir, in which the regions Z1 and Z2 are represented in dark gray.

The limit pressure at the bottom of the injection well is 6000 bar, and the limit pressure at the bottom of the production well is 80 bar.

The CMA-ES optimization algorithm is used to optimize the 12 parameters representing the two drainage areas (6 parameters for each area corresponding to the coordinates of the ends of each area). A population size is chosen that is equal to 40 individuals.

The parameters of the approximate model are as follows:
nᵢₙᵢₜ=1;
n_{b}=1;
number of individuals used for the local regression (=k): 100;
minimum size of the data structure: 150.

The initial population (of size 40) is randomly sampled in the regions defined. The best NPV value obtained on the initial population is equal to 9.87×10⁸.

The optimization uses 1312 flow simulations (56 iterations) to achieve an NPV value greater than 3.10⁹ (equal to 3.01.10⁹).

The method according to the invention therefore makes it possible to have an NPV value equal to 3 times the initial value found at the start of optimization (the best NPV obtained on the first iteration).

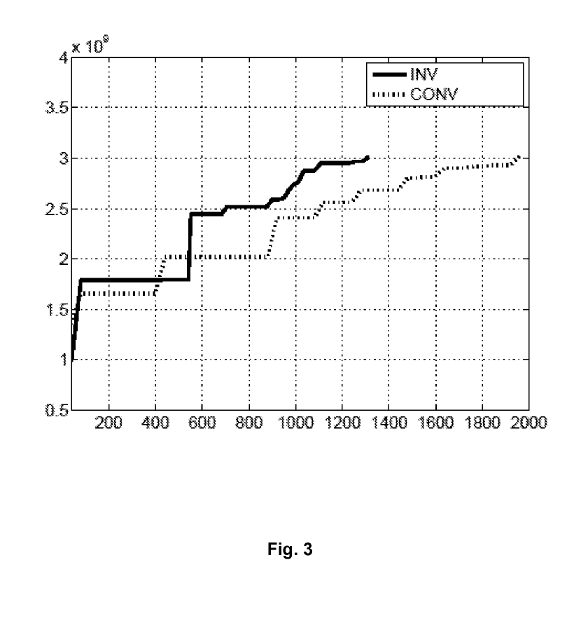

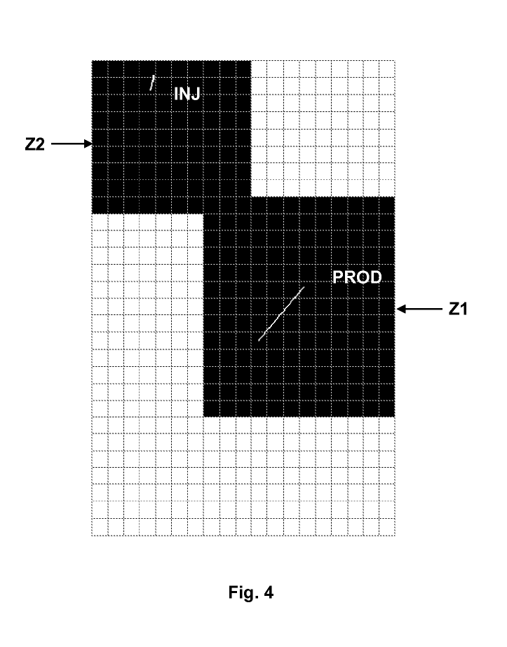

During the optimization process, the method according to the invention succeeds in finding the best area configurations (FIG. 3). FIG. 3 shows the trend of the best NPV value found by using the method according to the invention (INV) and compares it with that found while using a conventional approach (CONV). The X axis gives the number of flow simulations used. The Y axis gives the NPV value. The points on the curve mark the transition from one iteration to another. The best configuration is presented in FIG. 4 with the positions of the drainage area of the production well, denoted PROD, and the position of the drainage area of the injection well, denoted INJ.

PROD is defined by the two ends that have the coordinates (2587, 2658, 2385) and (2076, 2077, 2417). INJ is defined by the two ends that have for coordinates (711, 4872, 2421) and (674, 4729, 2417).

The use of the approximate model makes it possible to replace a certain number of flow simulations on each iteration (generation).

To achieve an NPV value greater than 3.10⁹, the method according to the invention uses 1312 flow simulations whereas a simple optimization with CMA-ES without the use of the approximate model requires 1960 flow simulations (FIG. 3). The reduction in the number of simulations, for this example, is equal to 33%.

In practice, the number of flow simulations is the stop criterion used to stop the optimization. It is proposed to set a maximum number of flow simulations equal to 1200. The method according to the invention therefore makes it possible to find a drainage area configuration which offers an NPV equal to 2.95.10⁹, whereas a simple optimization without the use of the approximate model offers an NPV equal to 2.56.10⁹. We have a gain of 15% on NPV.

Thus, by virtue of the method according to the invention, a better drainage area configuration is obtained by using fewer flow simulations.

1-7. (canceled)

8. A method for operating a hydrocarbon reservoir, in which placements for drainage areas within a hydrocarbon reservoir are determined, using a flow simulator and a reservoir model, in which drainage areas to be drilled within the reservoir are defined, and at least one quality criterion for the operation is chosen, comprising:
i. generating drainage area configurations randomly, by generating, for each configuration, placements for each drainage area;
ii. determining placements for each drainage area optimizing the quality criterion, by modifying the configurations by an iterative optimization algorithm during which:
for first iterations, the at least one quality criterion is evaluated by the flow simulator and the reservoir model; and for subsequent iterations
constructing an approximate evaluation model of the at least one quality criterion on a basis of a data structure containing a set of configurations associated with a criterion value obtained by the flow simulator;
evaluating a quality of the approximate model by an approximate ranking procedure; and
determining the quality criterion by the approximate model or by the flow simulator according to a quality of the approximate model.

9. A method according to claim 8, wherein the approximate model is defined by defining a distance between two configurations, by selecting k configurations of the data structure for which the distance relative to the configuration for which the criterion is evaluated is lowest, and by defining a quadratic model of the k configurations.

10. A method according to claim 7, wherein a quality of the approximate model is evaluated by carrying out the steps:
a. computing the quality criterion for each configuration by the approximate model and carrying out a first ranking of the configurations according to a value of the criterion for each configuration;
b. selecting n configurations associated with the highest criteria and computing the quality criterion for the n configurations by the flow simulator and the reservoir model with each configuration and each criterion being added to a data structure;
c. computing the quality criterion again for each configuration by the approximate model constructed on a completed data structure and carrying out a second ranking of the configurations according to a value of the criterion for each configuration; and
d. evaluating the quality of the approximate model by comparing the first ranking and the second ranking.

11. A method according to claim 8, in which the quality of the approximate model is evaluated by carrying out the steps:
a. computing the quality criterion for each configuration by the approximate model and carrying out a first ranking of the configurations according to a value of the criterion for each configuration;
b. selecting n configurations associated with the highest criteria and computing the quality criterion for the n configurations by the flow simulator and the reservoir model with each configuration and each criterion being added to a data structure;
c. computing the quality criterion again for each configuration by the approximate model constructed on a completed data structure and carrying out a second ranking of the configurations according to a value of the criterion for each configuration; and
d. evaluating the quality of the approximate model by comparing the first ranking and the second ranking.

12. A method according to claim 7, in which the steps i to iii are reiterated by varying a number of drainage areas.

13. A method according to claim 8, in which the steps i to iii are reiterated by varying a number of drainage areas.

14. A method according to claim 9, in which the steps i to iii are reiterated by varying a number of drainage areas.

15. A method according to claim 10, in which the steps i to iii are reiterated by varying a number of drainage areas.

16. A method according claim 7, in which the iterative optimization algorithm is a CMA-ES stochastic algorithm.

17. A method according claim 8, in which the iterative optimization algorithm is a CMA-ES stochastic algorithm.

18. A method according claim 9, in which the iterative optimization algorithm is a CMA-ES stochastic algorithm.

19. A method according claim 10, in which the iterative optimization algorithm is a CMA-ES stochastic algorithm.

20. A method according claim 11, in which the iterative optimization algorithm is a CMA-ES stochastic algorithm.

21. A method according claim 12, in which the iterative optimization algorithm is a CMA-ES stochastic algorithm.

22. A method according claim 13, in which the iterative optimization algorithm is a CMA-ES stochastic algorithm.

23. A method according claim 14, in which the iterative optimization algorithm is a CMA-ES stochastic algorithm.

24. A method according to claim 7, in which the drainage areas to be drilled include multiple-branched drains.

25. A method according to claim 8, in which the drainage areas to be drilled include multiple-branched drains.

26. A method according to claim 9, in which the drainage areas to be drilled include multiple-branched drains.

27. A method according to claim 10, in which the drainage areas to be drilled include multiple-branched drains.

28. A method according to claim 11, in which the drainage areas to be drilled include multiple-branched drains.

29. A method according to claim 12, in which the drainage areas to be drilled include multiple-branched drains.

30. A method according to claim 13, in which the drainage areas to be drilled include multiple-branched drains.

31. A method according to claim 14, in which the drainage areas to be drilled include multiple-branched drains.

32. A method according to claim 15, in which the drainage areas to be drilled include multiple-branched drains.

33. A method according to claim 16, in which the drainage areas to be drilled include multiple-branched drains.

34. A method according to claim 17, in which the drainage areas to be drilled include multiple-branched drains.

35. A method according to claim 18, in which the drainage areas to be drilled include multiple-branched drains.

36. A method according to claim 19, in which the drainage areas to be drilled include multiple-branched drains.

37. A method according to claim 20, in which the drainage areas to be drilled include multiple-branched drains.

38. A method according to claim 7, in which the quality criterion is computed for each configuration by approximate models corresponding to one or more drainage areas.
